(19) United States
(12) Patent Application Publication
(10) Pub. No.: US 2003/0056894 A1
(43) Pub. Date: Mar. 27, 2003

(54) Applicator for adhesively-impregnated tape

(76) Inventors: John Getz, Blachley, OR (US); Gilles Cyr, Eugene, OR (US)

Correspondence Address: Charles D. McClung, Chernoff, Vilhauer, McClung & Stenzel, LLP, 1600 ODS Tower, 601 S.W. Second Avenue, Portland, OR, 97204-3157, US

(21) Appl. No.: 09/963,200

(22) Filed: Sep. 25, 2001

(51) Int. Cl. B32B 31/26; B32B 1/00

(52) U.S. Cl. 156/307.7; 156/71; 156/166; 156/523; 156/574; 156/307.1

(57) ABSTRACT

An applicator of heat-reactive adhesive-impregnated tape has a pair of side-by-side, spaced-apart wheels which carry an endless belt. A support mechanism holds the belt against a moving sheet of material that the tape is being applied to. A tape dispenser heats the tape to melt its adhesive and feeds the heated tape onto the sheet of material. The tape travels with the sheet of material under the belt and the belt presses the tape into contact with the sheet of material. The distance between the wheels is such that the belt is in contact with the tape until the adhesive is completely cured.

### BACKGROUND AND SUMMARY OF THE INVENTION

This invention relates to an applicator for applying adhesive-impregnated tape to sheets of material, and in particular to such an applicator which holds melted tape on top of the sheet of material until it has completely cured.

Heat-reactive adhesive-impregnated tape is applied to sheets of material to hold the sheets together as the material is processed. One such application is in the manufacture of plywood and similar laminated materials. A dispenser heats the tape to melt the adhesive as the tape passes through it onto a moving sheet of material. A wheel is urged against the sheet of material to hold the tape in place while the sheet of material passes under the wheel. Since a wheel has a very limited contact area, the prior art wheel are chilled by passing refrigerated water through them in order to cure the adhesive quickly. While this works, the short period of time that the wheel is in contact with the tape still does not provide enough time for the adhesive to fully cure. As a result the tape slightly sticks to the wheel and does not perfectly adhere to the sheet of material. In addition, a refrigerated water cooling system is expensive to build and to operate.

This problem with the prior art tape applicators is overcome by the subject invention by replacing the single chilled wheel with a pair of spaced-apart wheels which carry an endless belt which contacts the tape. The distance between the axes of the wheels is such that the belt remains in contact with the tape until the adhesive is completely cured.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 is a prospective view of a tape applicator embodying the subject invention.

FIG. 2 is an exploded perspective view of the tape applicator of FIG. 1.

FIG. 3 is a side elevational view of the tape applicator of FIG. 1.

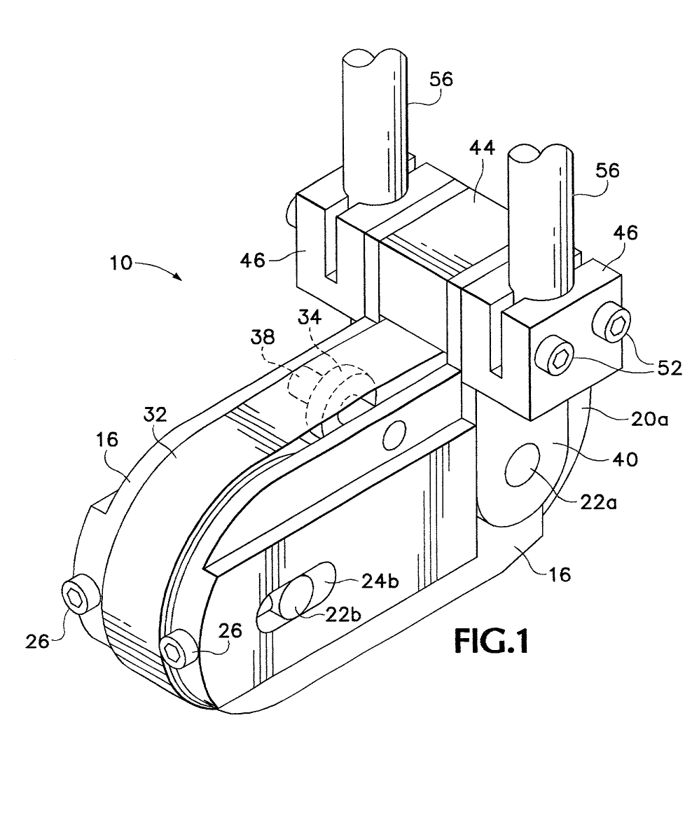

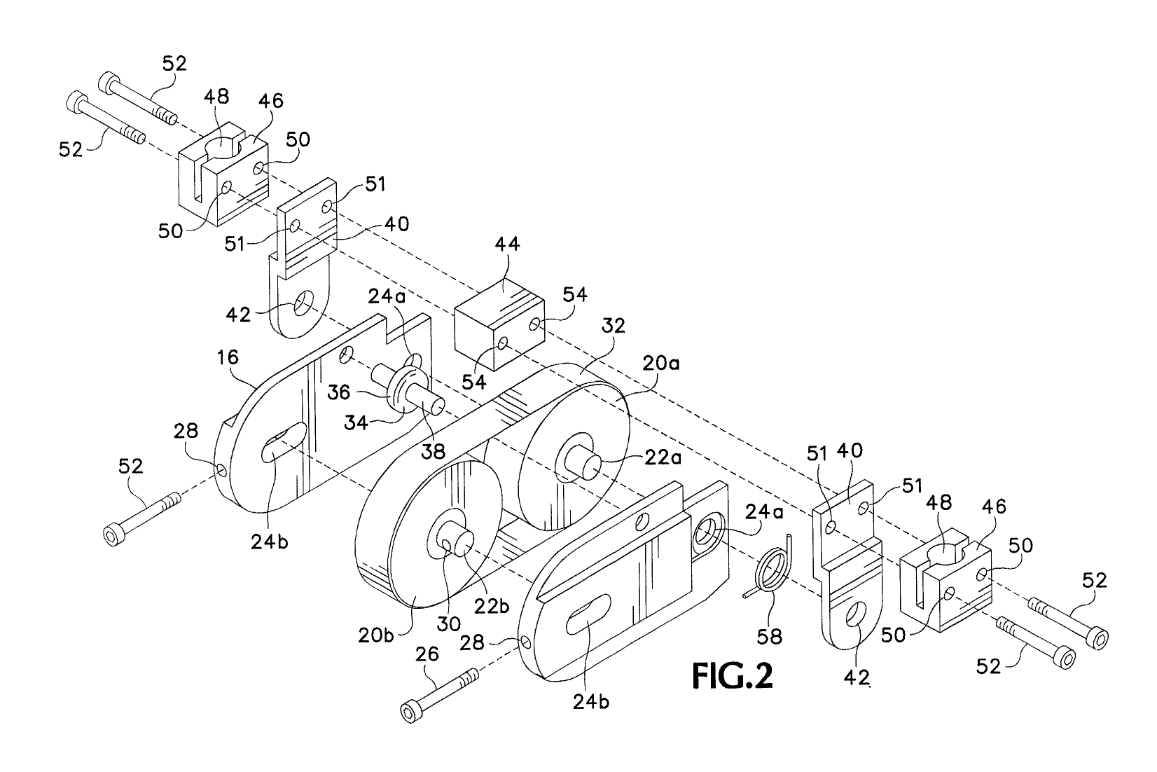

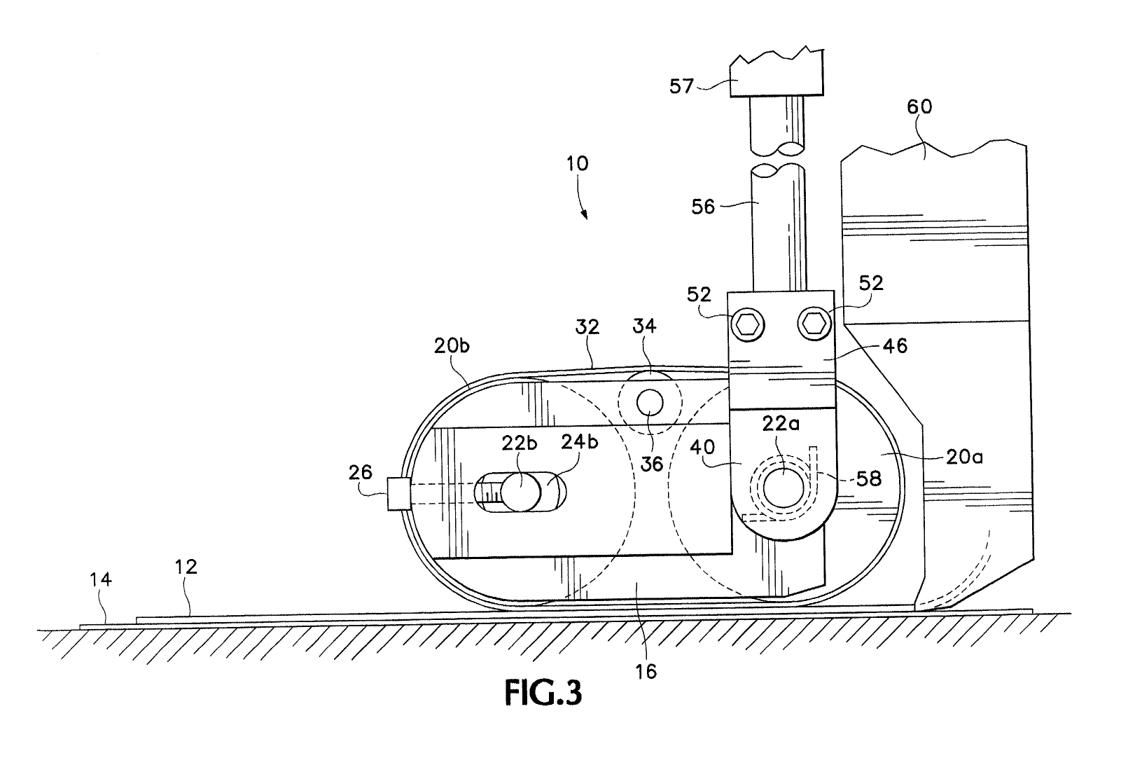

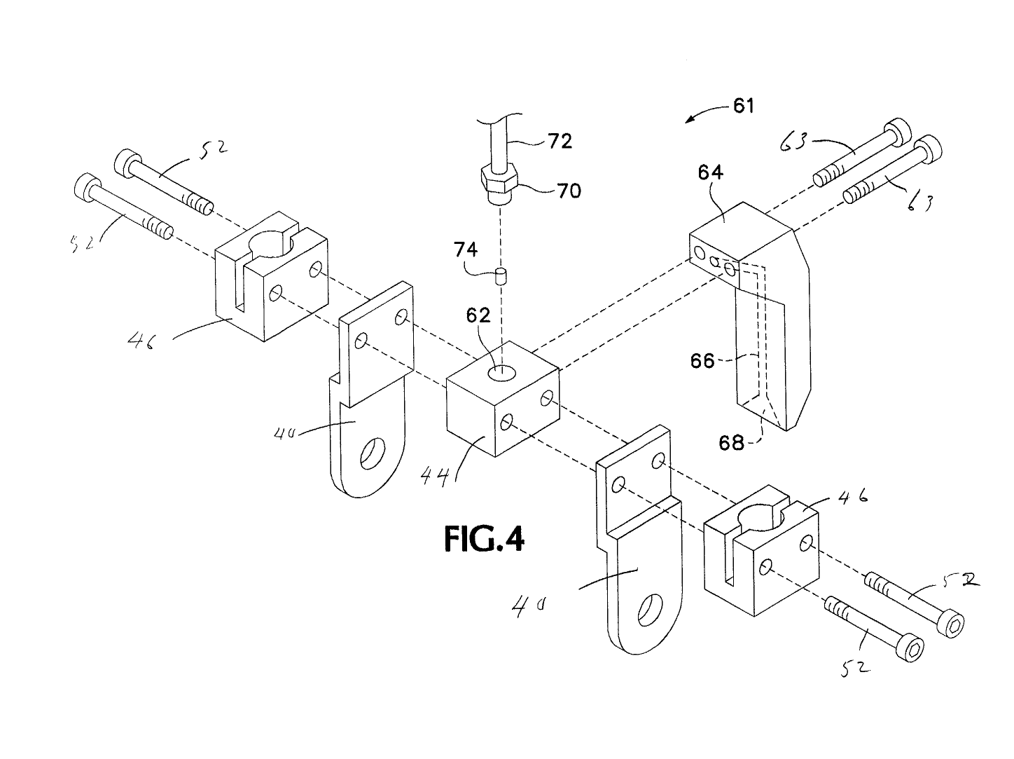

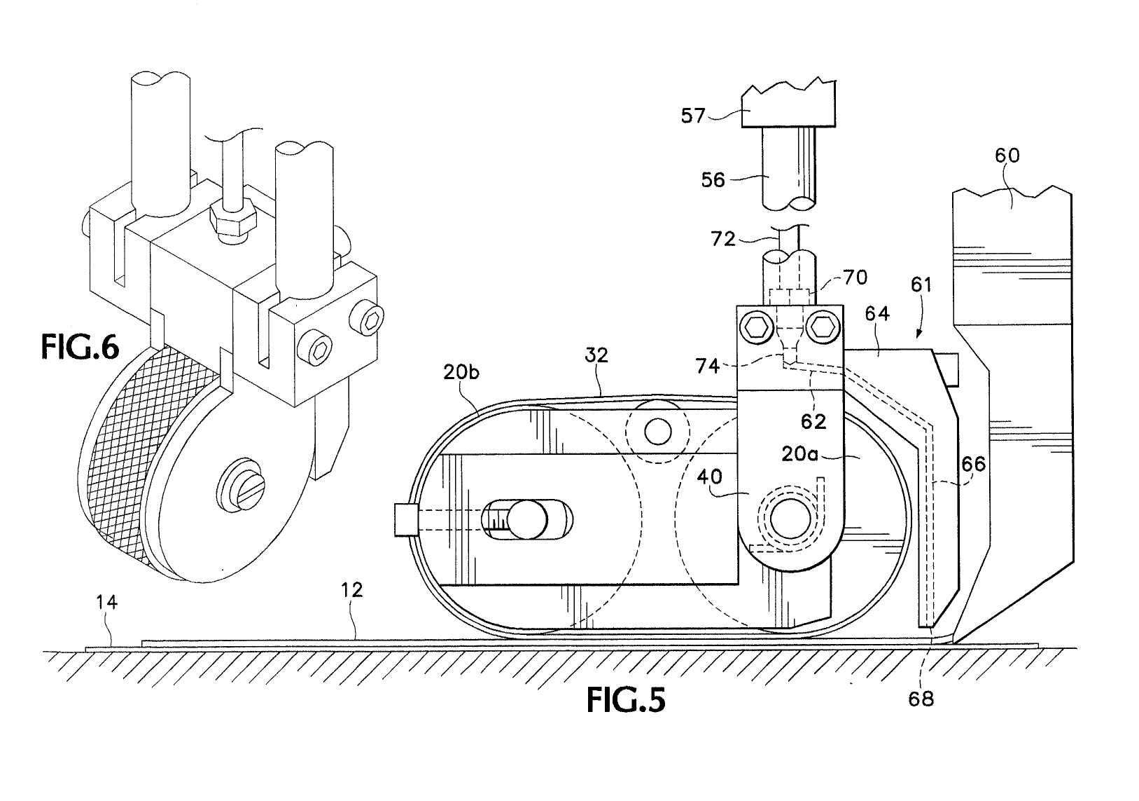

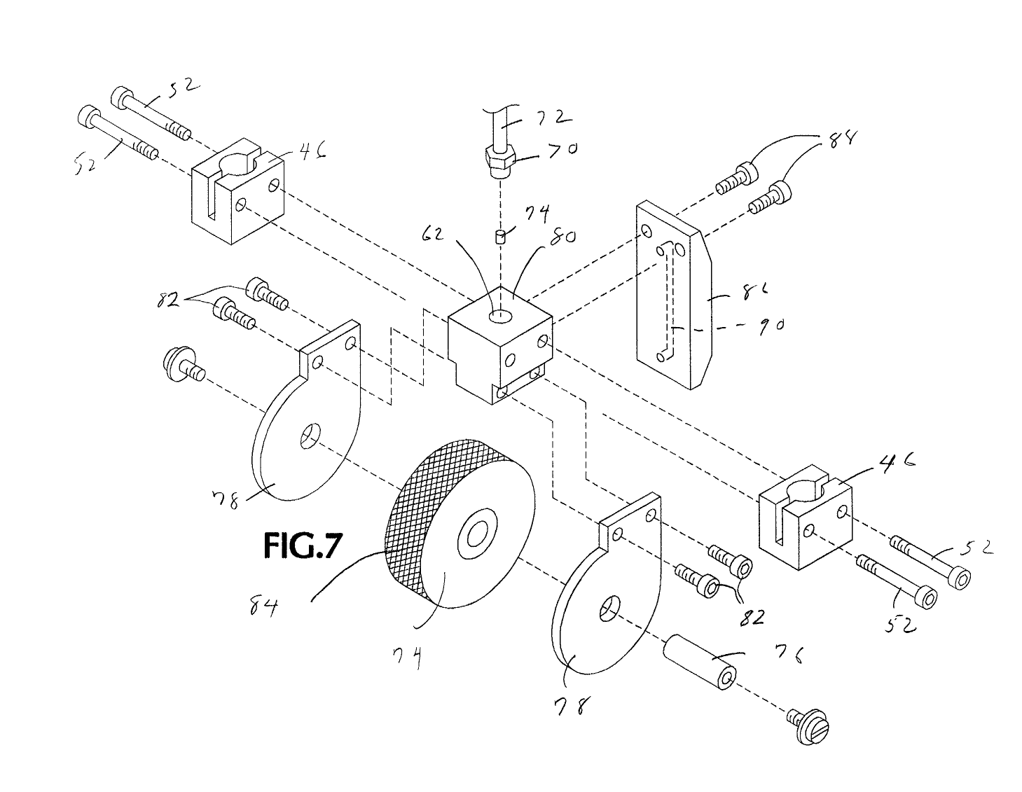

### DETAILED DESCRIPTION OF A PREFERRED EMBODIMENT

Referring to the drawings, an applicator 10 is used to apply adhesive impregnated tape 12 onto a sheet of material 14 which is being moved on a conveyor device, not shown. A particular type of tape which can be applied by the applicator 10 is a polyester yarn which is impregnated with a heat-reactive hot melt adhesive, such as ethyl vinyl acetate. Tape of this type is well known in the industry and is sold by applicant's assignee, Industrial Adhesives, Inc. under the trademark PLY TAPE. One use for this type of tape is to hold wood veneer sheets together as they are being joined with other sheets to form a multilayer veneer panel, not shown.

The applicator includes a pair of frames 16 which are in a side-by-side spaced-apart relationship with one another. Rotatably mounted between the frames 16 are a pair of wheels 20a, b. The wheels 20a, b are rotatably mounted on axles 22a, b, respectively, which are supported parallel to one another in openings 24a, b in the frames 16. The forward openings 24a are holes which tightly receive the associated axle 22a. The rear openings 24b are slots which allow the axle 22b to be moved toward and away from the axle 24a. Bolts 26 fit through openings 28 in the ends of the frames 16 and into threaded openings 30 at each end of the axle 22b. The axle 22b can be placed in the desired location in the slots 24b by rotating the bolts 26. Extending around the wheels 22a, b is an endless belt 32. Thus, the bolts 26 can be used to keep the belt tight on the wheels.

A crowned roller 34, which has an arcuate outer surface 36, is rotatably mounted between the wheels 22a, b on an axle 38 which extends between the frames 16 parallel with the axles 22a, b. The outer surface of the crowned roller 34 extends beyond the normal path of the belt as the belt passes between the wheels. The crowned roller is located approximately midway between the frames 16 so it lifts the center of the belt as the belt passes over it. This keeps the belt centered on the wheels 20a, b.

A mounting bracket 40 is located on the outside of each frame 16. The mounting brackets have openings 42 in them which the ends of the axle 22a rotatably extend through. Thus, the frames rotate relative to the mounting brackets. A spacer block 44 is located between the mounting brackets and a clamp 46 is located beside each mounting bracket. A hole 48 extends through each clamp 46 and bolts 52 pass through openings 50 in each clamp and openings 51 in each mounting bracket into threaded holes 54 in the spacer blocks to attach the clamps to the spacer block. A rod 56, which extends through the hole 48 in each clamp 46, is part of a support mechanism which holds the applicator and locates it above the sheet of material 14. Tightening the bolts 52 causes the clamps 46 to be squeezed on the rods 56. Thus, the applicator can be placed at the correct position to contact the sheet of material. A piston cylinder 57 raises and lowers the applicator and holds it tightly against the sheet of material. A spring 58 located between one of the frames 16 and its associated mounting bracket 40 causes the frame to rotate relative to the brackets.

A tape dispenser 60, of a type which is commercially available, is located in front of the applicator 10. The tape dispenser heats the tape 12 and feeds it onto the sheet of material 14 just before the sheet passes under the applicator. The belt then contacts the tape and holds it in place on the sheet of material until the adhesive has completely cooled. As a result, partially cooled tape does not adhere to the belt and become lifted off of the sheet of material and a complete bond is one between the tape and the sheet of material.

While the use of the endless belt 32 in place of a single roller eliminates the necessity of a refrigerated water cooling system, tape can be applied at higher speeds with this applicator if some external cooling is provided. Sufficient cooling can be provided to do this simply by blowing air onto the tape before it passes under the belt, which is far less complicated and costly to provide than refrigerated water. Referring now to FIGS. 4 and 5, an air cooling system 61 accomplishes this by providing an opening 62 which extends into the top of the spacer block 44 and opens out of its rear side. Attached to the rear side of the spacer block by means of bolts 63 is an air manifold 64. The air manifold 64 has an air passageway 66 defined in it. The inlet to the air passageway 66 communicates with the exit of the opening 62. The exit of the air passageway 66 flares outwardly at the bottom of the air manifold to provide a nozzle 68 which distributes air across the width of the tape before the tape passes under the belt. An air fitting 70, which is attached to the inlet of the opening 62, receives an air line 72. An air adjustment screw 74 fits within the air fitting 70 to regulate the amount of air which passes through the device.

A modification of the air cooling system 61 can be used to cool a prior art wheel without the necessity of having an expensive chilled water cooling system, if the wheel is slightly modified. Referring now to FIGS. 6 and 7, a single wheel 74 is rotatably mounted on an axle 76 which extends between a pair of mounting brackets 78 which are attached to a spacer block 80 by means of bolts 82. However, instead of having a smooth outer surface like the wheel used in the prior art applicators, the wheel 74 has an outer surface 84 with a pattern of grooves defined in it, such as by knurling. The spacer block 80 has an opening 62, like the opening 62 in the spacer block 44. An air fitting 70, having an air adjustment screw 74 and an air line 72 is located in the inlet of the opening 62.

An air manifold 86 is attached to the rear side of the spacer block by means of bolts 88. The air manifold 86 is similar to the air manifold 64 except that the air passageway 90 opens forwardly onto the wheel 74 rather than downwardly onto the tape. Air, which is introduced into the applicator through the air line 72, is exhausted onto the wheel 74 immediately before the wheel rotates onto the sheet of material which is passing under it. The grooves in the face 84 of the wheel increase the surface area that the air contacts which allows the air to cool the wheel more than would be the case with a wheel having a smooth surface. In addition, the grooves capture the air and allow it to remain in contact with the wheel as the wheel passes over the sheet of material the tape is being applied to, which also. increases its cooling effect.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

1. A device for holding adhesive-impregnated tape in place on a sheet of material which is being moved past said device until the adhesive has cured, comprising:
(a) a pair of wheels which rotate about spaced-apart axes which are parallel with the plane of said sheet of material;
(b) an endless belt which extends around said wheels; and
(c) a support mechanism which urges said belt against said sheet of material.

2. The device of claim 1, including a dispenser which feeds melted tape onto said sheet of material before said sheet of material moves under said belt.

3. The device of claim 2, including a frame which supports said wheels.

4. The device of claim 3 wherein said frame is rotatably attached to said support mechanism coaxially with the axis of one of said wheels.

5. The device of claim 4, including a biasing device which rotates said frame so that the other of said wheels is urged toward said sheet of material.

6. The device of claim 1, including a centering device which keeps said belt from moving off of said wheels.

7. The device of claim 6 wherein said centering device is a crowned roller, having an arcuate outer surface, which is rotatably mounted in said frame between said wheels, and projects into the path of said belt.

8. The device of claim 1, including an air cooling system which distributes air onto the melted tape before said tape moves under said belt.

9. The device of claim 8 wherein said air cooling system includes an exit nozzle which distributes air completely across said tape.

10. A device for holding adhesive impregnated tape in place on a sheet of material which is being moved past said device until the adhesive has cured, comprising:
(a) a wheel which rotates about an axis which is parallel with the plane of said sheet of material;
(b) said wheel having an outer surface which is in contact with said sheet of material;
(c) said wheel having a pattern of grooves defined in said outer surface; and
(d) an air manifold which allows air to be blown against the outer surface of said wheel immediately before said material is moved past said wheel.

11. The device of claim 10, including a dispenser which feeds melted tape onto said sheet of material before said sheet of material moves under said belt.
